(19) United States
(12) Patent Application Publication
(10) Pub. No.: US 2004/0019882 A1
(43) Pub. Date: Jan. 29, 2004

(54) Scalable data communication model

(76) Inventor: Robert J. Haydt, Seattle, WA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/206,458

(22) Filed: Jul. 26, 2002

(51) Int. Cl. G06F 9/45

(52) U.S. Cl. 717/151

(57) ABSTRACT

Methods, systems, and computer program products for processing one or more data communication operations such that the per-operation processing overhead decreases as the number of operations to process increases. Operations are inserted into work queues (e.g., transmit/receive) for processing by a hardware adapter controller. As processing for an operation completes, a completion queue entry is generated and inserted into a completion queue for the work queues. To receive completion queue notifications, a queue identifier is written to enable/notification settings, which are reset once a notification is generated. The notification is inserted into a status queue for completion queues. Status queue interrupts may be limited by being enabled only when all outstanding entries in the status queue have been processed. A completion status queue entry indicates completion of all previous control queue entries. Subsequent resource status information may be buffered until a current status entry is processed from the status queue.

### CROSS-REFERENCE TO RELATED APPLICATIONS

N/A

### BACKGROUND OF THE INVENTION

1. The Field of the Invention

The present invention relates to the field of data communication models. Specifically, the present invention relates to methods, systems, and computer program products for processing one or more data communication operations such that the per-operation processing overhead decreases as the number of operations to process increases.

2. Background and Related Art

With the increasing performance of computer hardware, the operation of computer software is becoming a more significant factor in overall system performance. Efficient computer software for interacting with hardware adapters that communicate with hardware devices is particularly important given the frequency and amount of information that tends to be changed. One typical communication bottleneck relates to various software layers and the corresponding interrupts, transitions between process modes, and other overhead, that often is imposed between an application and a hardware adapter.

Many operating systems provide at least two process modes: (i) a relatively less trusted and therefore more restricted user mode, and (ii) a relatively more trusted and therefore less restricted kernel mode. Generally, application processes run within user mode so that the processes are isolated and cannot interfere with each other's resources. User processes switch to kernel mode when making system calls, generating an exception or fault, when an interrupt occurs, etc. Processes running in kernel mode are privileged and have access to all computer resources (such as all available memory), without the restrictions that apply to user mode processes. Because the operating system kernel acts as a gatekeeper for computer resources, direct access to resources is generally limited to kernel mode processes. Distinctions between user mode processes and kernel mode processes also may be supported by computer hardware. For example, many microprocessors have processing modes to support the distinctions between user mode processes and kernel mode processes.

Because access to certain resources may be restricted to kernel mode processes, a user mode process may transition or switch to a kernel mode process to gain access. Following access, the process switches back to user mode for further execution. Switching process modes, however, can have a significant impact on performance. Therefore, in an effort to alleviate the performance degradation associated with switching process modes, some hardware adapters support enforcement of security measures within certain parameters so that user mode applications may access the hardware directly, without having to transition to kernel mode. Accordingly, some software drivers are able to bypass kernel mode for certain operations.

Despite allowing user mode processes direct access to hardware resources, the overall security of the computer system remains in tact by limiting access within specified security parameters. For the hardware adapter, these security parameters are set using kernel mode processes. Essentially, the security parameters indicate that a particular process is allowed direct access for certain operations. The hardware adapter will reject similar access attempts by other processes, and will reject access attempts by a process that are beyond the scope of permission granted by the security parameters.

As indicated above, interrupts that allow for asynchronous processing also may be a significant factor in the communication performance of a hardware adapter. Similar to people, when a microprocessor receives an interrupt it stops executing whatever task is being performed. The microprocessor saves some state information so it knows where to continue when finished processing the interrupt and begins executing the interrupt processing. Again, similar to people, if the microprocessor is interrupted to frequently, a disproportionate amount of time is spent shifting from one task to another, with relatively little time devoted to performing the operations needed to complete any given task. Accordingly, methods, systems, and computer program products for processing one or more data communication operations such that per-operation processing overhead decreases as the number of operations to process increases, are desired.

### BRIEF SUMMARY OF THE INVENTION

The present invention relates to methods, systems, and computer program products for processing one or more data communication operations such that the per-operation processing overhead decreases as the number of operations to process increases. One or more operations are inserted into one or more work queues for processing by a hardware adapter. A queue-specific identifier may be written to a work queue doorbell to notify the adaptor that an unprocessed entry has been inserted into the work queue. As processing completes for an operation, a completion queue entry is generated and inserted into a completion queue. Each completion queue holds completion queue entries for one or more work queues.

To receive completion queue notifications for completion queue entries, a queue-specific identifier associated with a completion queue may be written to both a completion queue enable setting and a completion queue notification setting. Then, in response to a completion queue entry, a completion queue notification is inserted into a status queue that holds completion queue notifications for one or more completion queues. The completion queue enable setting and completion queue notification setting are reset once a completion queue notification is generated. Operating system software, such as a driver, may be responsible for writing to the completion queue enable setting, whereas writing to the completion queue notification setting may be initiated by application software.

Interrupts from status queue entries, such as completion queue notifications, may be limited. For example, status queue interrupts may be enabled only when all outstanding entries in the status queue have been processed. The number of status entries inserted into the status queue also may be limited. For instance, a current status entry may be inserted into the status queue for a particular resource, with subsequent status information for the resource being buffered at least until the current status entry is processed from the status queue. Operations also may be inserted into a control queue for processing by the adapter. When a status queue entry indicates completion of a control queue entry, it also indicates completion of all previous control queue entries.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 shows a high-level block diagram of an application communicating with a hardware adapter in accordance with the present invention;

FIG. 2 illustrates an example data communication model in accordance with the present invention;

FIGS. 3A-3C show example acts and steps for methods of processing data communication operations in accordance with the present invention; and

FIG. 4 illustrates an example system that provides a suitable operating environment for the present invention.

### DETAILED DESCRIPTION OF THE PREFERRED EMBODIMENTS

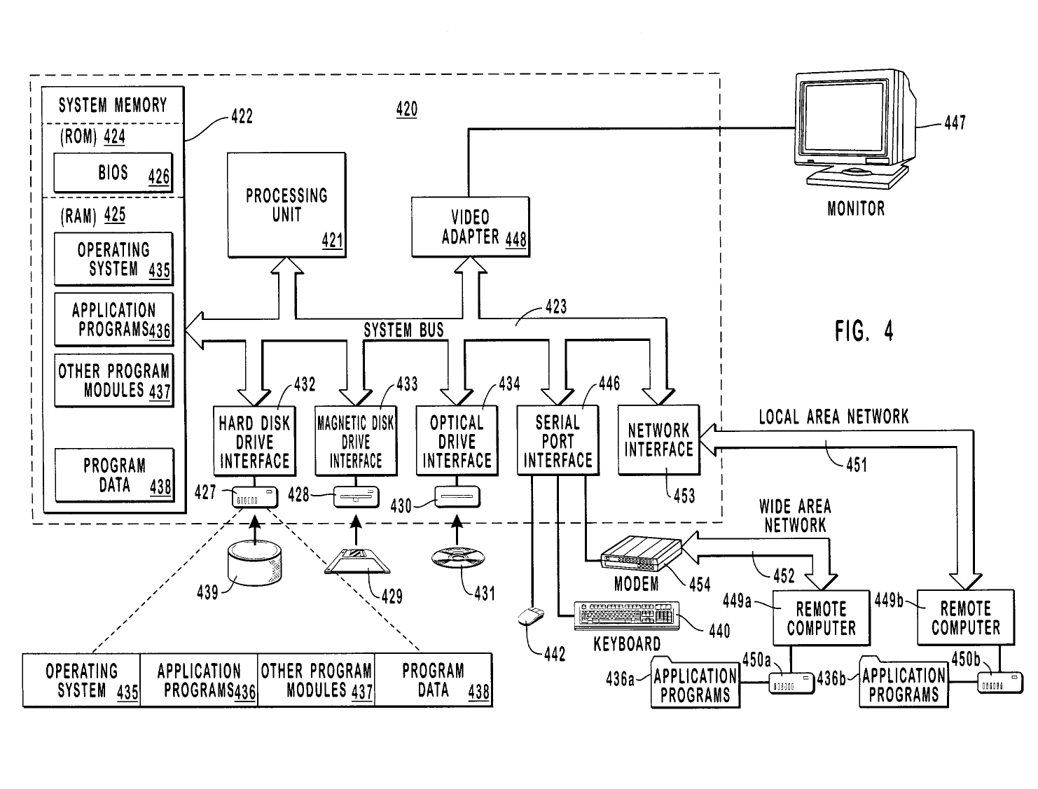

The present invention relates to methods, systems, and computer program products for processing one or more data communication operations such that the per-operation processing overhead decreases as the number of operations to process increases. Embodiments of the present invention may comprise one or more special purpose and/or one or more general purpose computers including various computer hardware, as discussed in greater detail below with respect to FIG. 4.

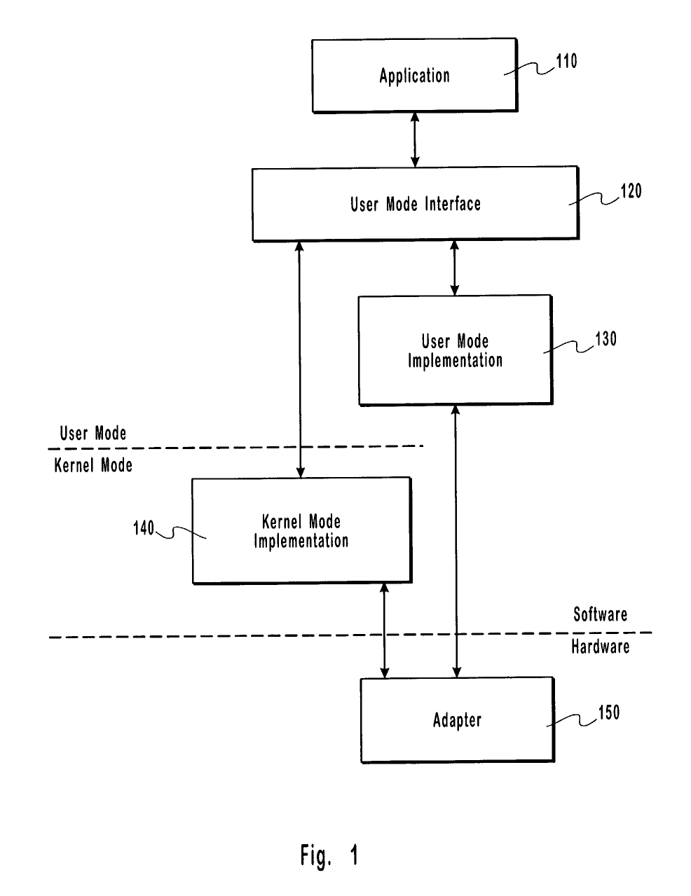

FIG. 1 shows a high-level block diagram of an application communicating with a hardware adapter in accordance with the present invention. An application 110 accesses adapter 150 through user mode interface 120. Some operations are mapped to kernel mode implementation 140, whereas others are mapped to user mode implementation 130. Note that user mode implementation 130 provides direct access to adapter 150, without switching to kernel mode. Accordingly, application 110 is able to access adapter 150 through user mode implementation 130 in significantly less time than would be required for kernel mode implementation 140. In one example embodiment, adapter 150 comprises an InfiniBand host channel adapter.

Some operations are implemented in both user mode implementation 130 and kernel mode implementation 140. For example, frequently used operations like sending and receiving information usually are included in user mode implementation 130 in order to achieve the performance benefits of avoiding a process transition from user mode to kernel mode. Although kernel mode implementation 140 generally includes operations that are unique to kernel mode, these operations often make use of operations for sending and receiving information from adapter 150. Because of the overhead that would be associated with switching from kernel mode to user mode in order to access user mode implementation 130 and then switching back to kernel mode, kernel mode implementation 140 generally implements at least some of the operations provided to Application 110 by user mode implementation 130. Furthermore, kernel mode implementation 130 generally includes all operations possible for adapter 150 so that applications without user mode interface 120 are able to interact with adapter 150 through kernel mode implementation 130.

Of course, some operations are unique to kernel mode implementation 140. For example, because the kernel is responsible for enforcing security, initiating and terminating access to adapter 150 occurs through kernel mode implementation 140. Once kernel mode implementation 140 (under the direction of application 110) provides the appropriate security parameters to adapter 150, adapter 150 performs the corresponding security checks when it is accessed, such as verifying that the accessing process has been properly authorized through kernel mode implementation 140.

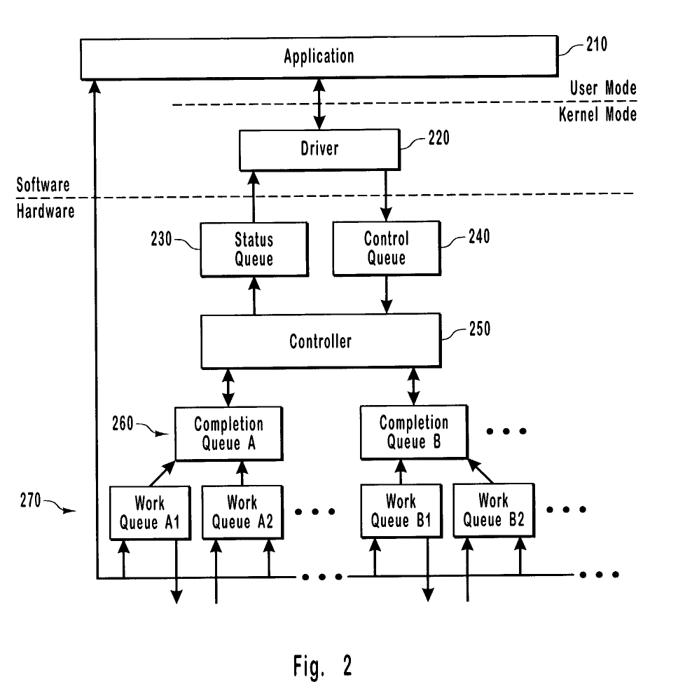

FIG. 2 illustrates an example data communication model in accordance with the present invention. The hardware (e.g., adapter 150 as shown in FIG. 1) multiplexes several links, many more connections and potentially just as many processes. In order to support this capability, the hardware aggregates the support overhead so that kernel mode processing in driver 220 and elsewhere is optimized. As the load on the hardware increases, the per-operation overhead in the kernel diminishes and applications, such as application 210, do not unduly impact the system by overwhelming the hardware and controller 250 with spurious interrupt driven processing. The hardware achieves this by:

(i) consolidating work queue notifications from work queues 270 into completion queues 260 and consolidating completion queue transitions notifications from completion queues 260 into the status queue 230;

(ii) eliminating unnecessary notifications by controlled enables for completion events and status queue interrupts;

(iii) implicit synchronization of all protected kernel operations using a single control queue 240 and a single status queue 230; and

(iv) implicit synchronization of all memory translation transitions.

The hardware has several mechanisms for communicating with software and mapping memory regions that are used for protected (kernel-mode) and application (user-mode) access. In particular, software populates entries in work queues 270 and control queue 240 and then passes control of them to the hardware by writing into a register associated with the appropriate resource. (As used in this application, the term “queue” does not necessarily imply any particular data structure and should be interpreted broadly to encompass any storage for a collection of one or more entries.) Once the register is written, the hardware reads the entry in the appropriate list and starts sequentially processing all outstanding list entries until all valid entries have been completed and the list entries have been returned to software (through either a completion or status update, in, for example, status queue 230). Software only needs to write the register once to trigger processing and it can append more items to be processed as long as the end of the list hasn't completed.

The hardware and software operate asynchronously and when the hardware reports a new entry in status queue 230 it may result in an interrupt. To reduce the number of interrupts and minimize the amount of protected kernel mode processing, the hardware enables interrupts only if the software has processed the outstanding entries. For example, in one embodiment the hardware maintains a context for the status queue 230 that includes a current entry index. Software writes the index of the current entry to the hardware. Interrupts are enabled if the value matches the current hardware index. If not, software hasn't finished processing all the entries and the enable is ignored. There is also a flag in the status queue entry that is set if the hardware generated an interrupt filling in the entry. The sequence used by software is:

(i) Process all the status queue 230 entries;

(ii) Write the index to the hardware; and

(iii) If there is a new entry in the status queue and the interrupt generated flag is clear (i.e., an interrupt was not generated when the entry was inserted), restart processing for all the entries.

An application 210 can request asynchronous notification for new completion queue entries. These notifications consume protected resources and also can generate additional interrupts so they may be carefully controlled. Protected kernel software, such as driver 220, enables completion queue notifications by writing the number or other identifier of the completion queue to a protected completion queue enable register. Software, such as application 210, triggers a completion queue notification by writing the application completion queue notify register. After both the enable and the notify have been written (they can be written in either order), the next completion queue entry causes a completion queue notification entry to be appended to the status queue 230 and both the enable and notify are reset. Resetting the enable and notify prevents applications from filling the status queue with notifications.

A direct translation map for accessing memory or other resources (by the various queues, controller 250, and other components) includes a list of physical page numbers and typically a few status bits. In one embodiment, a direct translation map is aligned on an eight byte boundary and fits within a physically aligned page. A direct map can be used anywhere a map is needed and is generally used for the control and status queues. If a direct map is associated with a virtual address range, the first entry in the translation list corresponds to the first page of the range. An indirect translation map starts on an aligned page boundary and consumes the entire page. Every entry in the page contains a physical page number (or it could be marked invalid). All of the referenced pages are direct translation maps, indirect translation maps or marked as invalid. The depth of the overall map is the number of pages accessed in order to reach a direct translation map entry. Assuming a eight byte translation entry and a 4 KB page, a map with depth 1 translates an address range of 2 MB; depth 2: 1 GB; and depth 3: 512 GB.

A buffer key is used with a scatter/gather list entry to identify a virtual address range. A buffer can contain either application data or transport addresses. Each queue pair (i.e., work queues organized as send and receive queue pairs) contains a base local key index and a base remote key index. The appropriate index from the queue pair is added to a buffer key before it is dereferenced. In one embodiment, a sequence number is masked from the buffer key and the resulting value is used to index into a key table.

The key table can be mapped by either a direct or indirect translation table. A key table entry ordinarily does not span translation entries. To allow buffer access: the translation for the key table entry should be valid, the sequence number should match, the key type and corresponding attributes should match, the range should fit within the buffer and be appropriately aligned, and the access should be allowed. A Key Table Entry contains a direct (indicated by depth 0) or indirect translation table for the buffer. The starting address of the range is subtracted from the starting address of the buffer and the resulting offset is used to index into the translation table.

The driver 220 for the hardware reads a configuration space and maps the appropriate sections of the hardware's address regions into the kernel address space. It also determines the starting address and length of the primary translation map and sets the registers accordingly. The driver 220 then allocates space for the control queue 240 and the status queue 230, initializes them, allocates space in the primary translation map, fills in the translation entries for the control and status queues and then sets the base and length registers for the two queues. The driver 220 allocates space for the key table map and sets the key table base and length registers. Using the control and status queues, various ports are initialized and in one embodiment, for each port, queue pairs 0 and 1 are setup.

All object context is manipulated through control queue 240 operations. The status queue 230 receives responses to control queue 240 operations and acts as the sink for all asynchronous notifications. The driver 220 fills control queue 240 entries sequentially and the hardware processes them roughly sequentially. In one example embodiment, control queue entries include: (i) set queue pair context; (ii) set completion queue context; (iii) set key table entry; (iv) invalidate key table entry; and (v) set port context. The driver 220 is responsible for not overrunning unprocessed queue entries.

When a status queue entry indicates that a control queue entry has completed it also indicates the completion of all previous control queue entries. While the controller 250 starts control queue 240 operations sequentially, some of them may not complete immediately and they can complete out of order (although in one embodiment they will be reported in the status queue in the same order requested). When a status queue entry indicates that a control queue operation has completed, the driver 220 can fill in another control queue entry that affects the same object context.

The status queue 230 receives control responses and asynchronous notifications. For example, in one embodiment, status queue entries include: (i) completion queue notification; (ii) queue pair context event; (iii) completion queue context event; (iv) key table context event; and (v) port context event. In order to indicate completion of a control queue entry, the controller 250 uses an available status queue entry. While the hardware is processing a control queue entry, it should make sure that there is an available status queue entry to receive a response. Asynchronous notification in a status queue entry indicates a change in state of an object. Each notification requires a response from the driver 220 before another notification will be delivered.

Conceptually, imagine that each object (queue pair, port, etc.) has a small buffer in its internal hardware context. When an asynchronous event occurs, that buffer is queued for delivery to the status queue and any succeeding asynchronous event that occurs on that object affects the object context but will not requeue the buffer until the driver 220 responds to the event. Eventually, the buffer gets to the head of the queue and when a status queue entry is available, the buffer (and possibly the current object context) is copied into it. The buffer is returned to the object but is not requeued to the status queue until the driver responds to the event (in an environment where there can be many queue pairs—perhaps tens of thousands, this prevents saturating the status queue 230). For completion queue notifications, the driver 220 responds by writing to the completion queue enable register. For other asynchronous events (like errors or unexpected state transitions), the driver responds by updating the affected object context.

In one embodiment, a completion queue includes a ring with a specific number of fixed size entries that are processed sequentially. The hardware has an index for each completion queue that it increments after it fills in each entry. When it reaches the last entry, it automatically resets the index back the beginning. As indicated above, the driver 220 enables status queue completion notification by writing the queue number or other identifier to the completion queue enable register. The Application 210 requests notification for a new completion queue entry by writing the queue number or other queue identifier to the completion queue notification register. After both registers are written (in either order), the next completion queue entry delivers a notification into the status queue 230 and resets the two registers.

The Application 210 typically insures that the number of entries on all the work queues (e.g., work queue A1, work queue A2, etc.) associated with the completion queue (e.g., completion queue A) doesn't exceed the completion queue's capacity. In one embodiment, a completion queue has a translation map associated with it (but there is no key table and there is no virtual address range associated with it). The driver 220 can extend the translation map and increase the capacity of the completion queue or it can reduce the capacity of the completion queue and shrink the translation map. For this embodiment, a completion queue entry does not span a page boundary.

As noted above, in one embodiment work queues 270 include one or more queue pairs for transmitting and receiving data. For example, a transmit queue may be implemented a linked list. Each queue entry has a fixed size, is naturally aligned, and does not span a page boundary. Even though a transmit queue may be implemented as a linked list, entries can be adjacent in the virtual address space. A “next adjacent” flag indicates that the next entry immediately follows and the hardware can simply read it without dereferencing the link, checking the key, etc., as long as the two entries are in the same page.

Each work queue context contains a pointer to the current entry. During work queue initialization, the context points to a “NoOp” entry. When an application adds an entry to the queue, it sets a “valid” flag of the new entry and fills in the key and address of the new entry into the link of the current entry at the tail of the queue. The application can write the queue number to a transmit doorbell register to notify the hardware that an unprocessed entry is on the queue. As described above, the hardware processes the work queue entries sequentially, storing the current pointer in the work queue context for each one until it reaches a NULL pointer in the next entry link or discovers that a “stall” flag is set in the current entry.

After the hardware stops processing entries, the application 210 restarts processing by writing the queue number to the transmit doorbell register. The hardware reads the next entry link from the last entry and, if the next entry link is not NULL, sets the current entry pointer and restarts processing (as long as the link is NULL, the hardware leaves the current entry pointer alone and doesn't restart processing no matter how many times the doorbell is written). If the application 210 needs to retrieve the queue entry at the tail of the list, a “NoOp” may be added to the queue (the one used during queue pair initialization is a likely candidate).

Valid entries on a transmit queue include NoOp, send, RDMA write, RDMA read, and bind. For the send and RDMA, an “address extension present” flag is set for datagram service. Also, a “remote buffer” flag is set for RDMA operations. An RDMA read generates a completion queue entry when the data transfer completes. Unless a fence bit is set, succeeding sends and RDMA writes in the transmit queue can be processed and generate completions. Accordingly, the RDMA read completion queue entry can then follow the completion queue entries for sends or RDMA writes that it preceded in the transmit queue.

For this embodiment, the receive queue also is implemented as a linked list. Each queue entry has a fixed size, is naturally aligned, and does not span a page boundary. Even though the receive queue is implemented as a linked list, entries can be adjacent in the virtual address space. Accordingly, a “next adjacent” flag indicates when the next entry immediately follows and the hardware can simply read it without dereferencing the link, checking the key, etc., as long as the two entries are in the same page.

The work queue context contains a pointer to the current entry. During work queue initialization, it points to a “NoOp” entry. When an application adds an entry to the queue, it sets the “valid” flag of the new entry and fills in the key and address of the new entry into the link of the current entry at the tail of the queue. The application 210 writes the queue number or other identifier to the receive doorbell register to notify the controller 250 that an entry is available on the queue. However, unlike the way a transmit queue drives the hardware until the queue is empty, a receive queue is mostly passive, supplying buffers to the hardware as incoming messages are received. There are also some active queued operations that don't involve data transfers and are processed as they reach the head of the queue.

The hardware retrieves the current work queue entry; stores the pointer in the work queue context, and, if for a receive buffer, the controller delays further processing on the queue until there's an incoming message. When an incoming message is received, the hardware processes it and moves on to the next queue entry. Processing stops if the next entry link is a NULL pointer or if a “stall” flag is set in the current entry.

After the hardware stops processing entries, the application 210 restarts processing by writing the queue number or other queue identifier to the receive doorbell register. The hardware reads the next entry link from the last entry and, if the next entry link is not NULL, sets the current entry pointer and restarts processing (as long as the link is NULL, the hardware leaves the current entry pointer alone and doesn't restart processing no matter how many times the doorbell is written). If the application 210 needs to retrieve the completed queue entry at the tail of the list, it may add a “NoOp” to the queue (the one used during queue pair initialization is a likely candidate). As the queue entries are processed, they generate completion queue entries unless a “silent” flag is set.

Valid entries on a transmit queue include NoOp, receive, and bind. As previously stated, the receive queue entry blocks the queue until an incoming message is received by the hardware. The NoOp queue entry completes immediately and the bind queue entry allows changes to buffer access that can be ordered with the receive operations.

In one embodiment a credits field is applicable to a reliable connected service. Before a message can be received, a credit has to be sent from the receiver to the transmitter. By allowing and application to manage credits, the hardware does not have to expend processing resources trying to figure out how many entries are on the receive queue. A receive buffer can increase the number of outstanding credits by a field specified in a standard header. For startup and any time all the receive buffers have been consumed, it is much more efficient to queue a credit message followed by a list of receive buffers all in a single operation.

The key table provides associations between keys, address ranges, and resources referenced through a queue pair that are associated with a particular application. A key has two components, a sequence number and an index. A queue pair has a remote key base index and a local key base index stored in the queue pair context. When a key is referenced, the appropriate base is added to the index to determine the key table index. The entry corresponding to the key table index contains the information for validating and referencing the corresponding buffer. For example, checks may be made to assure that:

(i) The key table index fits in the table, the key table entry is valid; the translation map entry is valid, a valid bit for the entry is set, and the sequence number matches (unless the entry has the match disabled);

(ii) The owner of the queue matches the owner of the key table entry (unless the entry has the match disabled);

(iii) The buffer range being accessed fits within the range specified in the key table entry;

(iv) The address being referenced matches the alignment;

(v) The type of reference (data, address vector, etc.) is allowed; and

(vi) The access (local r/w, remote r/w, bind) is allowed.

The hardware has a single key table that can be mapped by either a direct or indirect translation map. The driver 220 maintains the map and distributes the key table entries but the entries are only changed by the hardware. The driver 220 requests changes using control queue 240 operations, and applications, such as application 210, request changes using bind operations.

The present invention also may be described in terms of methods comprising functional steps and/or non-functional acts. The following is a description of acts and steps that may be performed in practicing the present invention. Usually, functional steps describe the invention in terms of results that are accomplished, whereas non-functional acts describe more specific actions for achieving a particular result. Although the functional steps and non-functional acts may be described or claimed in a particular order, the present invention is not necessarily limited to any particular ordering or combination of acts and/or steps.

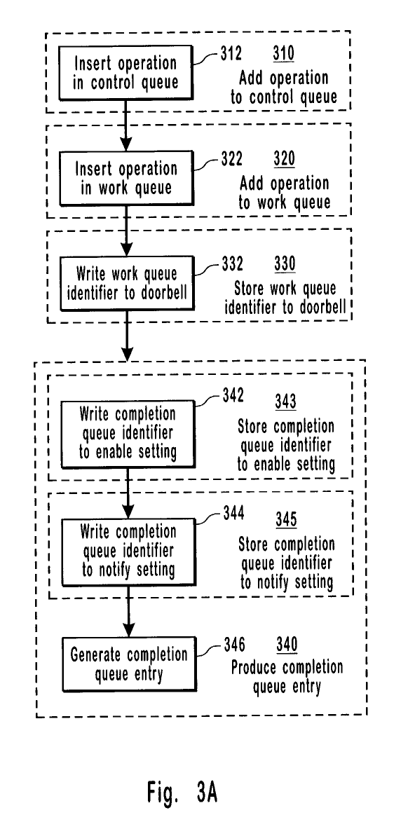

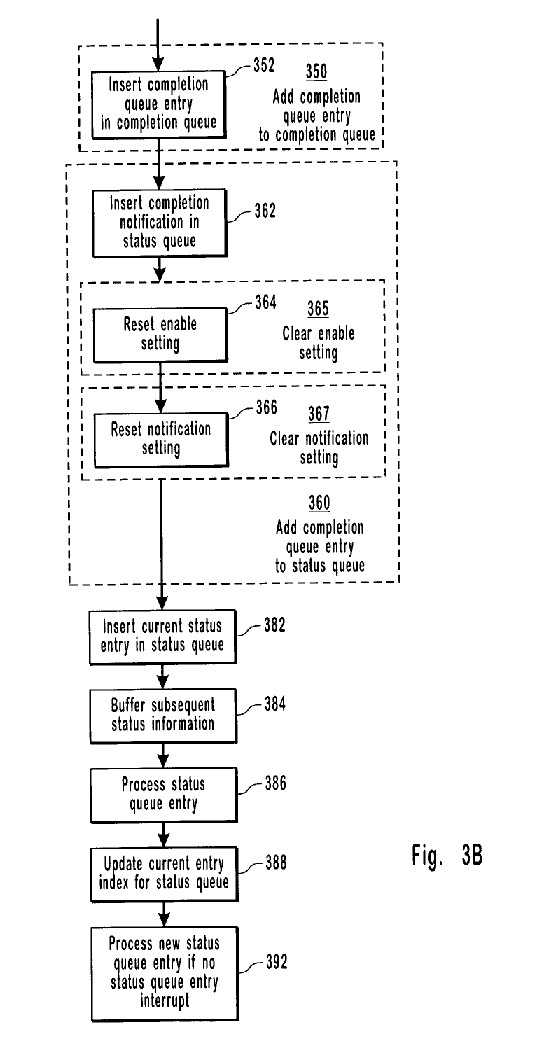

FIGS. 3A-3C show example acts and steps for methods of processing data communication operations in accordance with the present invention. A step for adding (310) one or more operations to a control queue that receives operations for processing by a hardware adapter controller may include an act of inserting (312) the one or more operation into the control queue. A step for adding (320) one or more operations to one or more work queues for processing by a controller of a hardware adapter may include an act of inserting (322) the one or more operations. Work queues may include, for example, transmit and receive queues. An act of storing (330) a queue-specific identifier to a doorbell, such as a transmit queue doorbell or a receive queue doorbell, may include an act of writing (332) the queue-specific identifier to the doorbell.

A step for producing (340) a completion queue entry for each of one or more operations in the one or more work queues that completes processing may include steps for storing (343) a queue-specific identifier associated with a completion queue in a completion queue enable setting and storing (345) the queue-specific identifier in a completion queue notification setting, and an act of generating (346) a completion queue entry. In turn, a step for storing (343) the queue-specific identifier in a completion queue enable setting may include an act of writing (342) the queue-specific identifier to the completion queue enable setting. Similarly, a step for storing (345) the queue-specific identifier in the completion queue notification setting may include an act of writing (344) the queue-specific identifier to a completion queue notification setting.

A step for adding (350) one or more completion queue entries to at least one of one or more completion queues may include an act of inserting (352) one or more completion queue entries into at least one of the one or more completion queues. A step for adding (360) one or more completion queue notifications to a status queue may include an act of inserting (362) one ore more completion queue notifications into the status queue, and may include steps for clearing (365) the completion queue enable setting and for clearing (367) the completion queue notification settings. In turn, a step for clearing (365) the completion queue enable setting may include an act of setting (364) the completion queue enable setting. Likewise, a step for clearing (367) the completion queue notification setting may include an act of resetting (366) the completion queue notification setting.

The present invention also may include acts of: inserting (382) a current status entry into the status queue for a particular resource; buffering (384) subsequent status information for the particular resource in one or more context objects at least until the current status entry is processed from the status queue; processing (386) one or more status queue entries in response to a status queue interrupt; updating (388) a current entry index for each status queue entry that is processed; and processing (392) a new status queue entry if the new status queue entry has a flag indicating that no interrupt was generated when the new status queue entry was inserted.

The embodiments of the present invention may comprise one or more special purpose and/or one or more general purpose computers including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

FIG. 4 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an exemplary system for implementing the invention includes a general purpose computing device in the form of a conventional computer 420, including a processing unit 421, a system memory 422, and a system bus 423 that couples various system components including the system memory 422 to the processing unit 421. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk drive 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 430a and 430b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 is connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. For a computer system comprising a hardware adapter with a controller that governs the hardware adapter's operation and software for communicating with the hardware adapter, a method of processing one or more data communication operations such that per-operation processing overhead decreases as the number of operations to process increases, the method comprising acts of:
inserting one or more operations into one or more work queues for processing by a controller of a hardware adapter;
for each of the one or more operations in one of the one or more work queues that completes processing, generating a completion queue entry;
inserting one or more completion queue entries into at least one of one or more completion queues, wherein each completion queue holds at least one completion queue entry for each of the one or more work queues; and
inserting one or more completion queue notifications into a status queue that holds at least one completion queue notification for each of the one or more completion queues.

2. A method as recited in claim 1, wherein the status queue reports status information relative to operations processed by the hardware adapter controller, the method further comprising an act of inserting one or more operations into a control queue that receives operations for processing by the hardware adapter controller.

3. A method as recited in claim 2, wherein a given status queue entry indicates that a particular control queue entry has completed, thereby also indicating completion of all previous control queue entries.

4. A method as recited in claim 1, wherein a queue-specific identifier is associated with each of the one or more completion queues, the method further comprising acts of:
for each of the one or more completion queue notifications inserted into the status queue:
writing the queue-specific identifier associated with one of the one or more completion queues to a completion queue enable setting;
writing the queue-specific identifier to a completion queue notification setting;
inserting an individual completion queue notification into the status queue when a completion queue entry is inserted into a completion queue corresponding to the queue-specific identifier; and
resetting the completion queue enable setting and the completion queue notification setting.

5. A method as recited in claim 4, wherein protected operating system software writes the queue-specific identifier to the completion queue enable setting, and wherein writing the queue-specific identifier to the completion queue notification setting is initiated by application software.

6. A method as recited in claim 1, wherein a status queue context comprises a current entry index for the status queue, and wherein status queue interrupts are enabled only if the current entry index matches an actual entry index, indicating that all outstanding entries in the status queue have been processed.

7. A method as recited in claim 6, wherein each status queue entry comprises a flag indicating whether an interrupt is generated when inserting the corresponding status queue entry, the method further comprising acts of:
in response to a status queue interrupt, processing one or more status queue entries;
updating the current entry index for each status queue entry that is processed; and
if a new status queue entry appears in the status queue with the corresponding flag indicating that no interrupt was generated when the new status queue entry was inserted, then processing the new status queue entry, and otherwise deferring processing of the new status queue entry for a subsequent status queue interrupt.

8. A method as recited in claim 1, wherein at least one of the one or more work queues comprises a transmit queue for communicating over a communication link, and wherein a queue-specific identifier is associated with the transmit queue, the method further comprising an act of writing the queue-specific identifier of the transmit queue to a transmit doorbell to notify the hardware adaptor controller that there is an unprocessed entry on the transmit queue.

9. A method as recited in claim 1, wherein at least one of the one or more work queues comprises a receive queue for communicating over a communication link, and wherein a queue-specific identifier is associated with the receive queue, the method further comprising an act of writing the queue-specific identifier of the receive queue to a receive doorbell to notify the hardware adaptor controller that there is an unprocessed entry on the receive queue.

10. A method as recited in claim 1, wherein the software for communicating with the hardware adapter comprises at least one of: (i) a device driver, (ii) a kernel-mode operating system software, and (iii) user-mode application software.

11. A method as recited in claim 1, wherein the hardware adapter controller maintains state information in one or more context objects for hardware adapter resources, the method further comprising acts of:
inserting a current status entry into the status queue for a particular resource; and
buffering subsequent status information for the particular resource in the one or more context objects at least until the current status entry is processed from the status queue.

12. For a computer system comprising a hardware adapter with a controller that governs the hardware adapter's operation and software for communicating with the hardware adapter, a method of processing one or more data communication operations such that per-operation processing overhead decreases as the number of operations to process increases, the method comprising steps for:
adding one or more operations to one or more work queues for processing by a controller of a hardware adapter;
for each of the one or more operations in one of the one or more work queues that completes processing, producing a completion queue entry;
adding one or more completion queue entries to at least one of one or more completion queues, wherein each completion queue holds at least one completion queue entry for each of the one or more work queues; and
adding one or more completion queue notifications to a status queue that holds at least one completion queue notification for each of the one or more completion queues.

13. A method as recited in claim 12, wherein the status queue reports status information relative to operations processed by the hardware adapter controller, the method further comprising a step for adding one or more operations to a control queue that receives operations for processing by the hardware adapter controller.

14. A method as recited in claim 13, wherein a given status queue entry indicates that a particular control queue entry has completed, thereby also indicating completion of all previous control queue entries.

15. A method as recited in claim 12, wherein a queue-specific identifier is associated with each of the one or more completion queues, the method further comprising steps for:
for each of the one or more completion queue notifications inserted into the status queue:
storing the queue-specific identifier associated with one of the one or more completion queues in a completion queue enable setting;
storing the queue-specific identifier in a completion queue notification setting;
adding an individual completion queue notification to the status queue when a completion queue entry is inserted into a completion queue corresponding to the queue-specific identifier; and
clearing the completion queue enable setting and the completion queue notification setting.

16. A method as recited in claim 15, wherein protected operating system software stores the queue-specific identifier to the completion queue enable setting, and wherein storing the queue-specific identifier to the completion queue notification setting is initiated by application software.

17. A method as recited in claim 12, wherein a status queue context comprises a current entry index for the status queue, and wherein status queue interrupts are enabled only if the current entry index matches an actual entry index, indicating that all outstanding entries in the status queue have been processed.

18. A method as recited in claim 17, wherein each status queue entry comprises a flag indicating whether an interrupt is generated when inserting the corresponding status queue entry, the method further comprising acts of:
in response to a status queue interrupt, processing one or more status queue entries;
updating the current entry index for each status queue entry that is processed; and
if a new status queue entry appears in the status queue with the corresponding flag indicating that no interrupt was generated when the new status queue entry was inserted, then processing the new status queue entry, and otherwise deferring processing of the new status queue entry for a subsequent status queue interrupt.

19. A method as recited in claim 12, wherein at least one of the one or more work queues comprises a transmit queue for communicating over a communication link, and wherein a queue-specific identifier is associated with the transmit queue, the method further comprising a step for storing the queue-specific identifier of the transmit queue to a transmit doorbell to notify the hardware adaptor controller that there is an unprocessed entry on the transmit queue.

20. A method as recited in claim 12, wherein at least one of the one or more work queues comprises a receive queue for communicating over a communication link, and wherein a queue-specific identifier is associated with the receive queue, the method further comprising a step for storing the queue-specific identifier of the receive queue to a receive doorbell to notify the hardware adaptor controller that there is an unprocessed entry on the receive queue.

21. A method as recited in claim 12, wherein the software for communicating with the hardware adapter comprises at least one of: (i) a device driver, (ii) a kernel-mode operating system software, and (iii) user-mode application software.

22. For a computer system comprising a hardware adapter with a controller that governs the hardware adapter's operation and software for communicating with the hardware adapter, a computer program product comprising a computer readable medium carrying computer executable instructions that implement a method of processing one or more data communication operations such that per-operation processing overhead decreases as the number of operations to process increases, the method comprising acts of:
inserting one or more operations into one or more work queues for processing by a controller of a hardware adapter;
for each of the one or more operations in one of the one or more work queues that completes processing, generating a completion queue entry;
inserting one or more completion queue entries into at least one of one or more completion queues, wherein each completion queue holds at least one completion queue entry for each of the one or more work queues; and
inserting one or more completion queue notifications into a status queue that holds at least one completion queue notification for each of the one or more completion queues.

23. A computer program product as recited in claim 22, wherein the status queue reports status information relative to operations processed by the hardware adapter controller, the method further comprising an act of inserting one or more operations into a control queue that receives operations for processing by the hardware adapter controller.

24. A computer program product as recited in claim 23, wherein a given status queue entry indicates that a particular control queue entry has completed, thereby also indicating completion of all previous control queue entries.

25. A computer program product as recited in claim 22, wherein a queue-specific identifier is associated with each of the one or more completion queues, the method further comprising acts of:
for each of the one or more completion queue notifications inserted into the status queue:
writing the queue-specific identifier associated with one of the one or more completion queues to a completion queue enable setting;
writing the queue-specific identifier to a completion queue notification setting;
inserting an individual completion queue notification into the status queue when a completion queue entry is inserted into a completion queue corresponding to the queue-specific identifier; and
resetting the completion queue enable setting and the completion queue notification setting.

26. A computer program product as recited in claim 22, wherein protected operating system software writes the queue-specific identifier to the completion queue enable setting, and wherein writing the queue-specific identifier to the completion queue notification setting is initiated by application software.

27. A computer program product as recited in claim 22, wherein a status queue context comprises a current entry index for the status queue, and wherein status queue interrupts are enabled only if the current entry index matches an actual entry index, indicating that all outstanding entries in the status queue have been processed.

28. A computer program product as recited in claim 27, wherein each status queue entry comprises a flag indicating whether an interrupt is generated when inserting the corresponding status queue entry, the method further comprising acts of:
in response to a status queue interrupt, processing one or more status queue entries;
updating the current entry index for each status queue entry that is processed; and
if a new status queue entry appears in the status queue with the corresponding flag indicating that no interrupt was generated when the new status queue entry was inserted, then processing the new status queue entry, and otherwise deferring processing of the new status queue entry for a subsequent status queue interrupt.

29. A computer program product as recited in claim 22, wherein at least one of the one or more work queues comprises a transmit queue for communicating over a communication link, and wherein a queue-specific identifier is associated with the transmit queue, the method further comprising an act of writing the queue-specific identifier of the transmit queue to a transmit doorbell to notify the hardware adaptor controller that there is an unprocessed entry on the transmit queue.

30. A computer program product as recited in claim 22, wherein at least one of the one or more work queues comprises a receive queue for communicating over a communication link, and wherein a queue-specific identifier is associated with the receive queue, the method further comprising an act of writing the queue-specific identifier of the receive queue to a receive doorbell to notify the hardware adaptor controller that there is an unprocessed entry on the receive queue.

31. A computer program product as recited in claim 22, wherein the software for communicating with the hardware adapter comprises at least one of: (i) a device driver, (ii) a kernel-mode operating system software, and (iii) user-mode application software.

32. A computer program product as recited in claim 22, wherein the hardware adapter controller maintains state information in one or more context objects for hardware adapter resources, the method further comprising acts of:
inserting a current status entry into the status queue for a particular resource; and
buffering subsequent status information for the particular resource in the one or more context objects at least until the current status entry is processed from the status queue.

33. For a computer system comprising a hardware adapter with a controller that governs the hardware adapter's operation and software for communicating with the hardware adapter, a computer program product comprising a computer readable medium carrying computer executable instructions that implement a method of processing one or more data communication operations such that per-operation processing overhead decreases as the number of operations to process increases, the method comprising steps for:
adding one or more operations to one or more work queues for processing by a controller of a hardware adapter;
for each of the one or more operations in one of the one or more work queues that completes processing, producing a completion queue entry;
adding one or more completion queue entries to at least one of one or more completion queues, wherein each completion queue holds at least one completion queue entry for each of the one or more work queues; and
adding one or more completion queue notifications to a status queue that holds at least one completion queue notification for each of the one or more completion queues.

34. A computer program product as recited in claim 33, wherein the status queue reports status information relative to operations processed by the hardware adapter controller, the method further comprising a step for adding one or more operations to a control queue that receives operations for processing by the hardware adapter controller.

35. A computer program product as recited in claim 34, wherein a given status queue entry indicates that a particular control queue entry has completed, thereby also indicating completion of all previous control queue entries.

36. A computer program product as recited in claim 33, wherein a queue-specific identifier is associated with each of the one or more completion queues, the method further comprising steps for:
for each of the one or more completion queue notifications inserted into the status queue:
storing the queue-specific identifier associated with one of the one or more completion queues in a completion queue enable setting;
storing the queue-specific identifier in a completion queue notification setting;
adding an individual completion queue notification to the status queue when a completion queue entry is inserted into a completion queue corresponding to the queue-specific identifier; and
clearing the completion queue enable setting and the completion queue notification setting.

37. A computer program product as recited in claim 36, wherein protected operating system software stores the queue-specific identifier to the completion queue enable setting, and wherein storing the queue-specific identifier to the completion queue notification setting is initiated by application software.

38. A computer program product as recited in claim 33, wherein a status queue context comprises a current entry index for the status queue, and wherein status queue interrupts are enabled only if the current entry index matches an actual entry index, indicating that all outstanding entries in the status queue have been processed.

39. A computer program product as recited in claim 38, wherein each status queue entry comprises a flag indicating whether an interrupt is generated when inserting the corresponding status queue entry, the method further comprising acts of:
in response to a status queue interrupt, processing one or more status queue entries;
updating the current entry index for each status queue entry that is processed; and
if a new status queue entry appears in the status queue with the corresponding flag indicating that no interrupt was generated when the new status queue entry was inserted, then processing the new status queue entry, and otherwise deferring processing of the new status queue entry for a subsequent status queue interrupt.

40. A computer program product as recited in claim 33, wherein at least one of the one or more work queues comprises a transmit queue for communicating over a communication link, and wherein a queue-specific identifier is associated with the transmit queue, the method further comprising a step for storing the queue-specific identifier of the transmit queue to a transmit doorbell to notify the hardware adaptor controller that there is an unprocessed entry on the transmit queue.

41. A computer program product as recited in claim 33, wherein at least one of the one or more work queues comprises a receive queue for communicating over a communication link, and wherein a queue-specific identifier is associated with the receive queue, the method further comprising a step for storing the queue-specific identifier of the receive queue to a receive doorbell to notify the hardware adaptor controller that there is an unprocessed entry on the receive queue.

42. A computer program product as recited in claim 33, wherein the software for communicating with the hardware adapter comprises at least one of: (i) a device driver, (ii) a kernel-mode operating system software, and (iii) user-mode application software.

43. A computer program product for processing a collection of one or more data communication operations such that per-operation processing overhead decreases as the number of operations to process increases, the computer program product comprising a computer readable medium carrying computer executable instructions that implement:
a plurality work queues that each hold one or more operations for processing by a hardware adapter controller;
a plurality of completion queues that each hold one or more completion queue entries, one for each of the plurality work queue operations that completes processing, wherein each completion queue holds completion queue entries from multiple work queues; and
a status queue that holds at least one completion queue notification from multiple completion queues.

44. A computer program product as recited in claim 43, wherein the status queue reports status information relative to operations processed by the hardware adapter controller, the computer readable medium carrying computer executable instructions further implementing a control queue that receives operations for the hardware adapter controller to process.

45. A computer program product as recited in claim 44, wherein a given status queue entry indicates that a particular control queue entry has completed, thereby also indicating completion of all previous control queue entries.

46. A computer program product as recited in claim 43, wherein a queue-specific identifier is associated with each of the plurality of completion queues, the computer readable medium carrying computer executable instructions that further implement acts of:
for each of the one or more completion queue notifications inserted into the status queue:
writing the queue-specific identifier associated with one of the one or more completion queues to a completion queue enable register;
writing the queue-specific identifier to a completion queue notification register;
inserting an individual completion queue notification into the status queue when a completion queue entry is inserted into a completion queue corresponding to the queue-specific identifier; and
resetting the completion queue enable register and the completion queue notification register.

47. A computer program product as recited in claim 43, wherein protected operating system software writes the queue-specific identifier to the completion queue enable register, and wherein writing the queue-specific identifier to the completion queue notification register is initiated by application software.

48. A computer program product as recited in claim 43, wherein a status queue context comprises a current entry index for the status queue, and wherein status queue interrupts are enabled only if the current entry index matches an actual entry index, indicating that all outstanding entries in the status queue have been processed.

49. A computer program product as recited in claim 48, wherein each status queue entry comprises a flag indicating whether an interrupt is generated when inserting the corresponding status queue entry, the computer readable medium carrying computer executable instructions that further implement acts of:
in response to a status queue interrupt, processing one or more status queue entries;
updating the current entry index for each status queue entry that is processed; and
if a new status queue entry appears in the status queue with the corresponding flag indicating that no interrupt was generated when the new status queue entry was inserted, then processing the new status queue entry, and otherwise deferring processing of the new status queue entry for a subsequent status queue interrupt.

50. A computer program product as recited in claim 43, wherein at least one of the one or more work queues comprises a transmit queue for communicating over a communication link, and wherein a queue-specific identifier is associated with the transmit queue, the computer readable medium carrying computer executable instructions that further implement a transmit doorbell to notify the hardware adaptor controller that there is an unprocessed entry on the transmit queue when the queue-specific identifier of the transmit queue is written to the transmit doorbell.

51. A computer program product as recited in claim 43, wherein at least one of the one or more work queues comprises a receive queue for communicating over a communication link, and wherein a queue-specific identifier is associated with the receive queue, the computer readable medium carrying computer executable instructions that further implement a receive doorbell to notify the hardware adaptor controller that there is an unprocessed entry on the receive queue when the queue-specific identifier of the receive queue is written to the receive doorbell.

52. A computer program product as recited in claim 43, wherein the software for communicating with the hardware adapter comprises at least one of: (i) a device driver, (ii) a kernel-mode operating system software, and (iii) user-mode application software.
